(19) United States
(12) Patent Application Publication
(10) Pub. No.: US 2022/0176279 A1
(43) Pub. Date: Jun. 9, 2022

(54) AIR CONDITIONER CONDENSATE FILTRATION DEVICE

(71) Applicant: Solomon Getachew Feleke, Murphy, TX (US)

(72) Inventor: Solomon Getachew Feleke, Murphy, TX (US)

(21) Appl. No.: 17/544,356

(22) Filed: Dec. 7, 2021

Related U.S. Application Data
(60) Provisional application No. 63/122,448, filed on Dec. 7, 2020.

(51) Int. Cl. B01D 35/30; B01D 35/157; C02F 1/00; B01D 29/60

(52) U.S. Cl. CPC B01D 35/30; B01D 35/1573; C02F 1/001; C02F 2101/20; B01D 2201/16; B01D 2201/309; B01D 2201/31; B01D 29/605

(57) ABSTRACT

A filtration device is configured to be connected to an existing condensate drain line of a heating, cooling, and ventilation system. The filtration device is configured to collect metal and other debris as the condensate moves through the device and prevents the condensate drain line from getting a clog. When a clog is present or other issues affect a level of condensate to rise in the device and stop from draining properly, the device is configured to shut off the heating, cooling, and ventilation system. Alternatively, the device is configured to provide an alternate pipe for drainage.

### CROSS-REFERENCE TO RELATED APPLICATIONS

This application is a non-provisional application which claims priority to Provisional Patent Application No. 63/122,448 filed on Dec. 7, 2020, which is incorporated by reference in its entirety.

### FIELD OF THE DISCLOSURE

The overall field of this invention generally pertains to a device for separating debris and ferrous particles from a flowing fluid network, such as a central heating or air conditioning system.

### BACKGROUND

A common problem with a heating, ventilation, and air conditioning (HVAC) may be found in the condensate drain line. The condensate drain line is one of the most important components of the HVAC system as it drains excess moisture from the appliance to the outside of a home to maintain proper functionality of the system. As air is heated or cooled inside the HVAC system, humidity is released which eventually turns into condensation. The condensate drain line essentially functions to drain the condensate. The condensate drain line connects directly to the HVAC units and leads outdoors, typically through a sink drain and/or an exterior wall of the home. Most condensate drain lines utilize gravity to move the condensate down the drain. The condensate drain lines may become clogged by debris including metal particles, dust, or dirt. When this happens, the condensate drain line does not efficiently drain the moisture down the line and can lead to water backing up the line and leaving moisture inside the HVAC system which can lead to a multitude of problems. The best indication that the condensate drain line is clogged may be an inefficient HVAC system where the unit may constantly turn on and off without significantly doing the required job. Most often, a technician would need to diagnose and remedy the problem accruing significant cost for the homeowner.

Accordingly, several ideas have been implemented to solve the above problem of a condensate drain line in an HVAC system becoming clogged. These solutions implement numerous approaches to removing debris from the condensate drain line. However, these solutions use complicated mechanisms which are not straightforward to an inexperienced homeowner. Thus, there remains a need for an economical, simple, and effective means of removing debris from the condensate drain line to prevent a HVAC system from shutting down or working inefficiently.

### SUMMARY

The present disclosure recognizes the unsolved need for an improved, more economical, simple, and effective means of removing debris from a condensate drain line. In one or more embodiments provided herein, the present disclosure relates to a filtration device configured for installment on a condensate line of a heating, a ventilating, and a cooling system (HVAC system). The filtration device described herein is configured to remove metal chips/fragments and other debris that could cause blockage in an air conditioner's condensate drain line. The filtration device comprises of a housing, an inlet, an outlet, and a vent. The inlet and the outlet allow the filtration device to be installed within an existing drain line on the HVAC unit. The housing collects the condensate moving through the drain line of the HVAC system through the inlet and drains the condensate out of the housing through the outlet. The debris settles to the bottom of the housing.

In one or more embodiments, a magnet is placed at the bottom of the filtration device which attracts small metal shavings and other debris which tend to settle to the bottom of the filtration device.

In one or more embodiments, the filtration device may be fashioned from a transparent material to permit one to visually inspect the inside of the filtration device to determine an amount of debris collected such that the filtration device may be cleaned.

In one or more embodiments, a float switch within the filtration device may determine if the system is clogged or backed up and shut off the A/C unit.

In one or more embodiments, a valve integrated to the inlet is electrically connected to the float switch wherein upon the float switch being activated by a clog in the filtration device, the valve opens and allows condensate from the HVAC system to continue to drain to an outside from a pipe connected to the inlet.

It is an object of the present invention to provide an improved, more economical, simple, and effective means of removing debris from a condensate drain line. It is also the object of the present invention to provide a condensate drain line filter that is easy to install on an existing condensate drain line. Additionally, it is also the object of this present invention that the condensate drain line filter is clear or opaque to allow one to visually detect the amount of debris collected. It is also the object of the present invention that the condensate drain line filter has an easy means of draining and cleaning the filter. Other aspects and advantages of the present disclosure will become apparent upon consideration of the following description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of a non-limiting embodiment of a filtration device.

FIG. 2 is a perspective view of a non-limiting embodiment depicting an internal view of a filtration device.

FIG. 3 is an exploded view of a non-limiting embodiment of the filtration device.

FIG. 4 is a perspective view of an alternate embodiment of a filtration device with a valve.

FIG. 5 is a perspective view of the alternate embodiment depicting the internal view of the filtration device.

FIG. 6 is an exploded view of the alternate embodiment of the filtration device with a valve.

FIG. 7 is an environmental view of the embodiment from FIG. 1 connected to a condensate drain line of a heating, cooling, and ventilation system.

FIG. 8 is an environmental view of the embodiment from FIG. 4 connected to a condensate drain line of a heating, cooling, and ventilation system.

### DETAILED DESCRIPTION

In the Summary above and in this Detailed Description, and the claims below, and in the accompanying drawings, reference may be made to particular features of the invention. It may be understood that the disclosure of the invention in this specification includes all possible combinations of such particular features. For example, where a particular feature may be disclosed in the context of a particular aspect or embodiment of the invention, or a particular claim, that feature can also be used, to the extent possible, in combination with and/or in the context of other particular aspects and embodiments of the invention, and in the invention generally.

Where reference may be made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” may be used herein to mean “serving as an example, instance, or illustration.” Any aspect described in this document as “exemplary” may not be necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

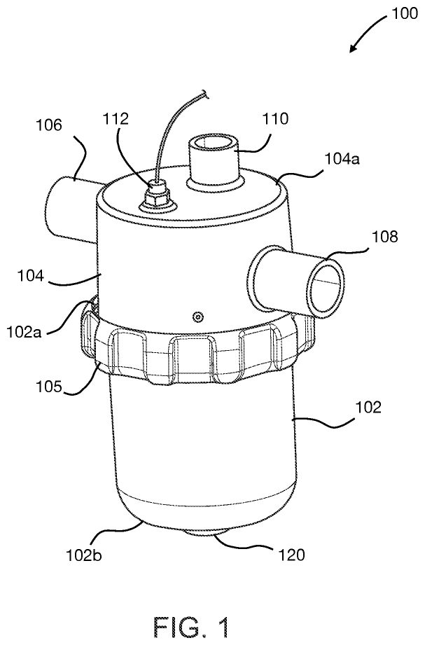

Referring now to the figures, FIGS. 1-3 illustrate a non-limiting embodiment of a condensate drain line filtration device 100 which will be referred to as a filtration device 100 for the remainder of the disclosure. The filtration device 100 may be connected to a drainage pipe of a HVAC unit at any location and adapted to receive condensate from a drainage pipe and permit condensate to flow through the filtration device 100 while restricting or preventing debris from flowing through. The filtration device 100 generally comprises a reservoir 102 with a hollow interior having an internal volume. The filtration device 100 also comprises an inlet 106, an outlet 108, a vent 110, and a float switch 112. In some embodiments, the filtration device 100 is also comprised of a magnetic element 120 disposed either within or outside of the reservoir 102.

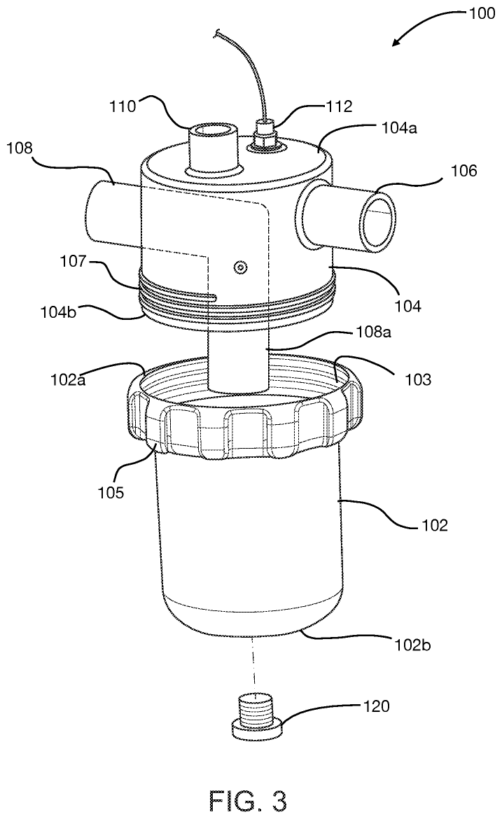

The reservoir 102 may generally be a rigid structure having a cylindrical form. The reservoir 102 may have a top end 102a and a bottom end 102b, wherein the top end 102a is open and the bottom end 102b is closed. The reservoir 102 may include a cover 104 that is connected to the top end 102a. The reservoir 102 is positioned below the cover 104 and is preferably removable from the cover 104. As seen in the figures, the cover 104 may also be a rigid structure and having a generally cylindrical form corresponding with the cylindrical form of the reservoir 102. The cover 104 may also have a top end 104a and a bottom end 104b wherein the top end 104a is closed and the bottom end 104b is open. The bottom end 104b of the cover 104 matingly engages with the top end 102a of the reservoir 102 to sealingly close the cover 104 onto the reservoir 102 and to form a hollow enclosure. As best seen in FIG. 3, the top end 102a of the reservoir 102 and the bottom end 104b of the cover 104 include connection means to matingly engage with each other to be detachable from each other. Such mating means may include and not be limited to corresponding male and female threads. As seen in FIG. 3, the reservoir 102 and the cover 104 include threads 103, 107, respectively. The reservoir 102 can be detached from the cover 104 allowing a person to inspect and clean the interior of any debris that may have accumulated within the reservoir 102. As seen in the figures, the reservoir 102 has a longer length and therefore more interior volume than a length and an interior volume of the cover 104 to hold the condensate draining into the reservoir 102 from a HVAC system. It is to be understood that the cover 104 and the reservoir 102 can vary in shape and size and have internal volumes that are the same or vary between the cover 104 and the reservoir 102.

FIGS. 1-3 also show that an outside surface of the reservoir 102 includes a raised and indented surface along the top end 102a, which may be referred to as a grip portion 105. The grip portion 105 may function to provide a person a portion to properly grip to twist the reservoir 102 to connect or disconnect from the cover 104. The grip portion 105 may be fashioned from the same material as the reservoir 102 or alternatively be fashioned from a material providing a better grip such as and not limited to a rubber material.

FIGS. 1-3 also show that the reservoir 102 may have a curved bottom end 102b. The advantage of having a curved bottom end 102b provides for any debris present in the condensate entering the reservoir to move downward and accumulate relatively near a center of the bottom end 102b. It is also to be understood that the reservoir 102 may have a flat bottom end 102b.

The reservoir 102 of the filtration device 100 may be fashioned from any suitable material including and not limited to plastic, metal, or ceramic. Examples of suitable plastics may include and not be limited to polyvinyl chloride (PVC), thermoplastic, etc. In various non-limiting embodiments, the reservoir may be transparent or clear to allow a person to see the interior of the reservoir 102 for accumulation of any debris, a clog, or any other issues visually detectable. An alternate embodiment of a filtration device 100 may comprise of a one-piece reservoir 102, wherein the reservoir 102 and the cover 104 are manufactured as a one-piece reservoir instead of separately connectable to the cover 104 and wherein both a top end and a bottom end of the one-piece would be closed. In such an embodiment, the inlet 106 and the outlet 108 would be configured onto the one-piece reservoir. It is also to be understood that the reservoir 102 may be made of a non-transparent plastic or any other non-transparent material. It is also to be understood that the cover 104 may be fashioned from the same materials as the reservoir 102 or can vary in material.

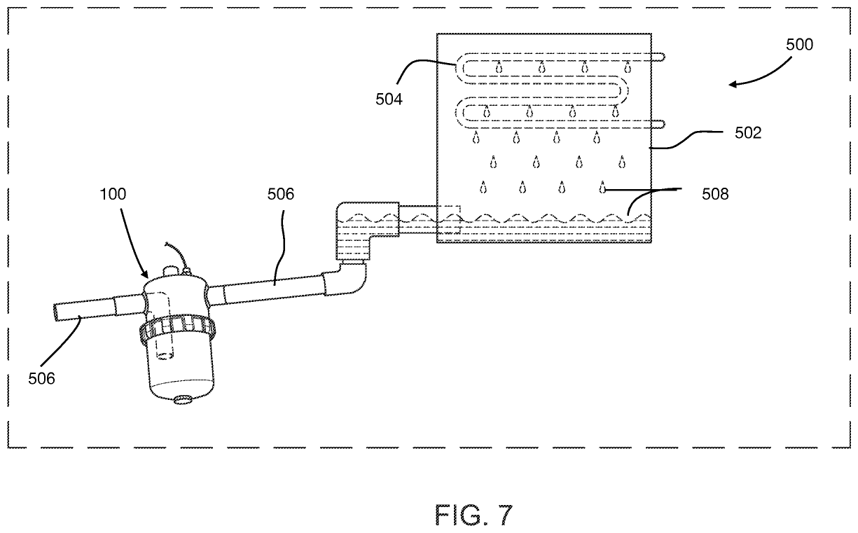

Still referring to FIGS. 1-3, the filtration device 100 also comprises of the inlet 106 and the outlet 108. The inlet 106 and outlet 108 are openings into the cover 104 and function to connect the filtration device 100 to an existing condensate drain line (See 506, FIG. 7) of an HVAC system. The condensate drain line connecting to the inlet 106 is upstream of the filtration device 100 and the condensate drain line connecting to the outlet 108 is downstream of the filtration device 100. The inlet 106 and the outlet 108 also allow the condensate from the HVAC unit to drain into and out of the reservoir 102, respectively. In the non-limiting preferred embodiment, the inlet 106 and the outlet 108 will preferentially be configured on the cover 104. In the alternate embodiment where the reservoir 102 may be a one-piece construction and not including the cover 104, the inlet 106 and outlet 108 will be configured near a top portion along a side surface of the reservoir 102.

Referring to the non-limiting embodiment shown in the FIGS. 1-3, the inlet 106 and the outlet 108 are shown as cylindrical pipes that may fit into an existing condensate drip line of a HVAC system. Preferentially, the inlet 106 and the outlet 108 may be integrally formed into the cover 104. Alternatively, the inlet 106 and the outlet 108 may not be integrally formed into the cover 104 and instead may be separate components secured to the cover 104. In general, the inlet 106 and the outlet 108 may be configured on a side of the cover 104 and are arranged opposite each other on the cover 104. The inlet 106 and the outlet 108 may generally have a circular cross section and be of a size such that it may snugly fit over an existing condensate drip line or may be adapted with additional pipe elements to fit over an existing drip line.

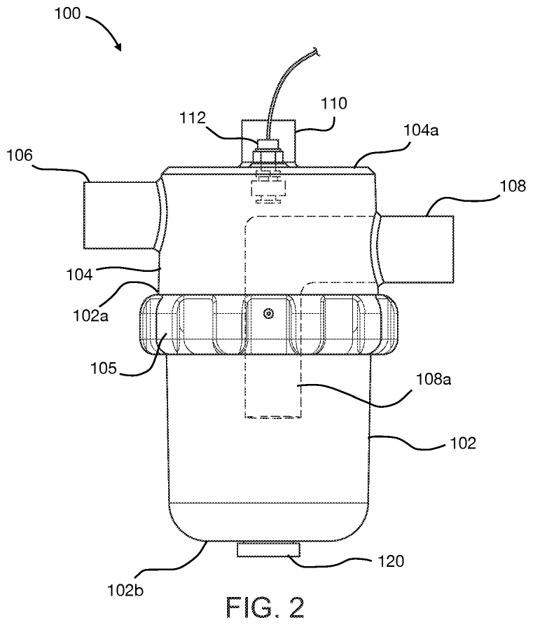

The inlet 106 and the outlet 108 components may also be arranged within the enclosure formed by the cover 104 and the reservoir 102 connected. As best seen in FIGS. 2 and 3, the outlet 108 has an internal pipe portion 108a that has a bent structure. The internal pipe portion 108a extends into the enclosure from the cover 104 and bends toward the reservoir 102 to be partially disposed within the reservoir 102. The Figures also show that the outlet 108 is relatively lower in the cover 104 than the inlet 106. The arrangement of the outlet 108 being configured a little lower on the cover 104 and further having the internal pipe portion 108a extending into the reservoir 102 can be appreciated to support a proper flow in to and out of the reservoir 102. It is to be understood, that in alternate embodiments, the outlet 108 may not include the internal pipe portion but be configured lower than the inlet 106 on the cover 104 such that the condensate flows out the outlet when it reaches the level of the outlet 108.

As illustrated in FIGS. 1-3, the filtration device 100 may also be comprised of the vent 110 which may be configured on the top end 104a of the cover 104. In the alternate embodiment of the one-piece housing, the vent 110 may be configured on a top portion of the reservoir 102. The vent 110 helps maintain proper atmospheric pressure in the filtration device 100 and allows fluid to flow smoothly through the inlet 106 and the outlet 108.

The filtration device 100 may additionally be provided with the magnetic element 120. As best seen in FIG. 2 the magnetic element 120 may be placed within the reservoir 102 at the bottom end 102b. The magnetic element 120 may be disposed relatively within a center of the end 102b. It is contemplated that the magnetic element 120 may be configured as a plug with threaded elements (as shown in FIG. 3) allowing the magnetic element 120 to be removably secured to an opening on the bottom of the reservoir portion 102 which may also be provided with threads allowing the magnetic element 120 and the opening in the reservoir's bottom end 102b to matingly engage. It will be appreciated that a proper seal may be formed with an O-ring that may be disposed on the magnetic element 120 which prevents any condensate from leaking through. It is to be understood that the filtration device 100 may comprise of a plug without a magnetic element that matingly engages with an opening relatively in the center of the bottom end 102b of the reservoir 102. Here, the non-magnetic plug may still function to open and drain the condensate from the bottom end 102b. It is also to be understood that the reservoir 102 may not comprise of a plug or any means to open the bottom end 102b.

Advantageously, having the magnetic element 120 disposed on the bottom end 102b of the reservoir 102 allows the efficient removal of any magnetic metal debris. Usually, the condensate drips into the reservoir 102 and, since most debris within the condensate will be heavier than the water in the condensate, the debris will start to settle to the bottom. Any magnetic debris present in the condensate will also start to settle and will be attracted toward the magnetic element 120. Another advantage having a magnetic element 120 that is removably secured to the bottom end 102b of the reservoir 102 is that it allows easy access to the filtration device 100 to drain and clean the interior of the filtration device without having to unscrew the reservoir 102 from the cover 104 or from removing the entire filtration device 100 from the condensate drain line if the embodiment is the one-piece reservoir which does not have a cover 104.

Referring to FIGS. 1-3, the filtration device 100 may also be comprised of the float switch 112. In the illustrated embodiment, the float switch 112 is sealingly integrated into the top end 104a of the cover 104 and extends into the cover 104 such that it is positioned just above the outlet 108. The float switch 112 functions to prevent the filtration device 100 from overflowing and from the condensate filling up and backing up into the inlet 106 and toward the HVAC system. The float switch 112 is normally closed; if the float rises, it is supposed to open the connection. The float switch 112 is electrically connected to a 24-volt transformer of an HVAC. If the float switch 112 is activated, the activation will disconnect the 24-volt transformer, effectively turning the HVAC system off. Usually, a thermostat of the HVAC system will go blank because there is no power, thus alerting a person that the HVAC unit has shut off and something may be wrong.

The filtration device 100 may encounter an issue where it is not working properly or there is a clog in the filtration device 100 resulting in the condensate not being drained out of the filtration device 100. If the filtration device 100 were to encounter such an issue, the condensate draining into the reservoir 102 from the inlet 106 will cause the condensate level to rise and start to fill up the reservoir 102. The condensate level rising above the outlet 108 and reaching the float switch 112 results in the float switch 112 being activated. When this happens, the float switch 112 will then send a message to the HVAC unit and the HVAC unit will shut off. When the HVAC unit shuts off, a person is usually alerted that there is a problem because the thermostat will go blank. At this time, the person may go to the filtration device 100 to see if there is a clog or some other issue. If the reservoir 102 is made from a clear material, the person may be able to visually determine if there is a clog or not. If the condensate in the reservoir is clear and there does not appear to be a clog, then it can usually indicate a clog somewhere in the condensate drain line which is downstream of the filtration device 100.

It is also contemplated that the float switch mechanism may induce an audible alarm to alert that the mechanism has been tripped. Additionally, it is also contemplated that the float switch mechanism may be connected to a software application on a mobile device which may be alerted when the mechanism is tripped. An alternate embodiment may include a wet switch which would also be placed within the cover 104 just above the outlet 108. The wet switch is normally dry and upon detecting moisture, the wet switch mechanism will send a message to the AC unit to shut off.

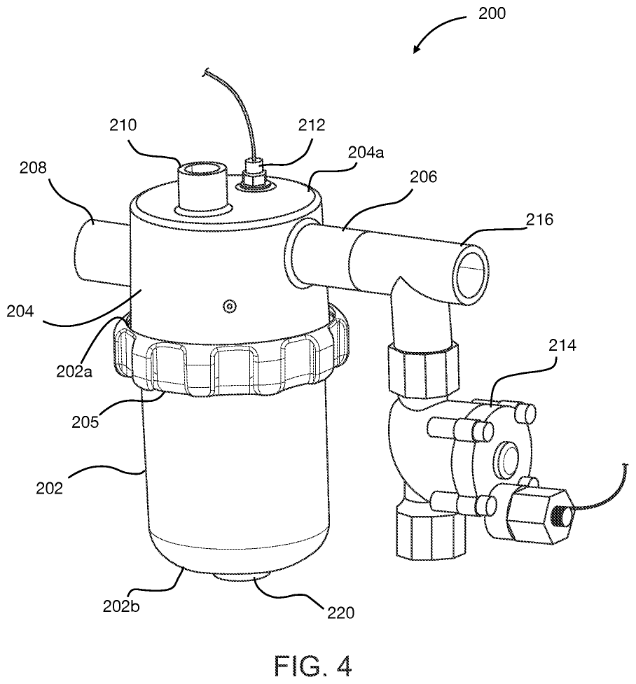

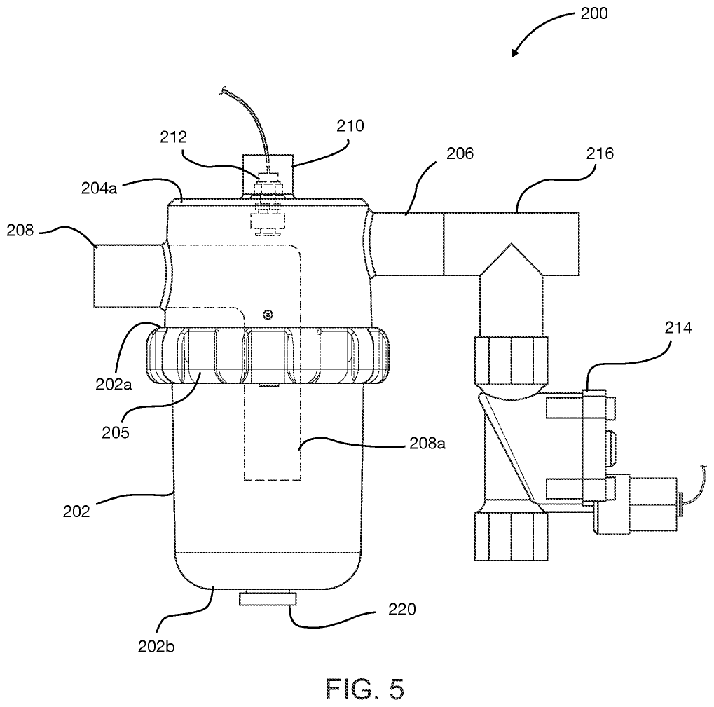

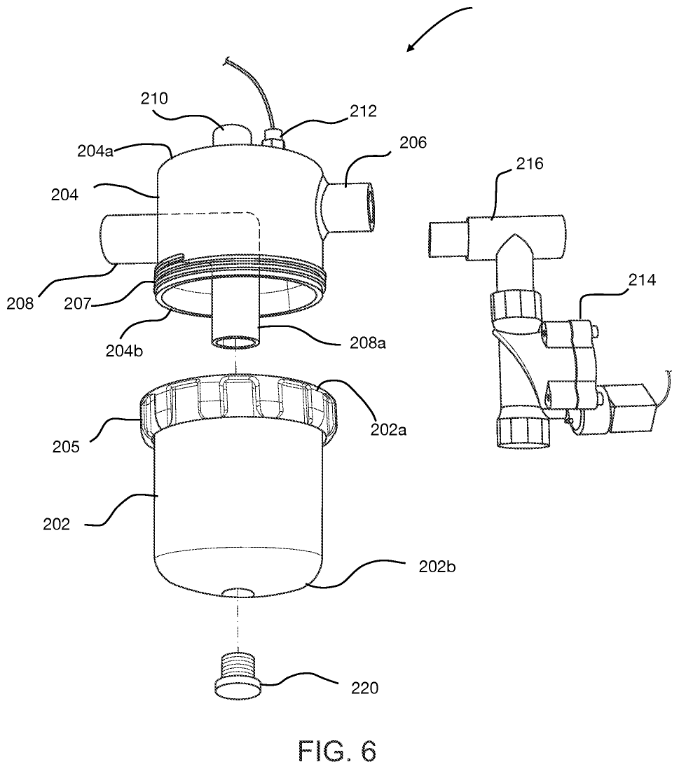

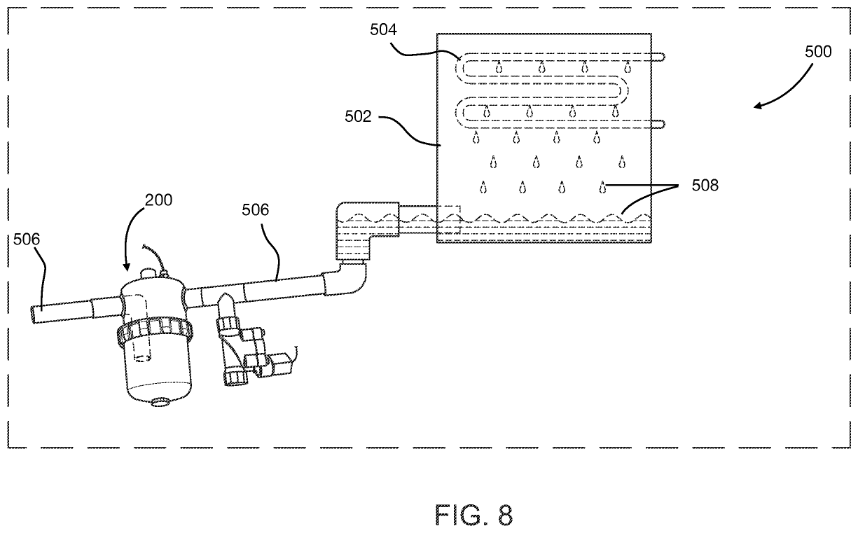

An alternate embodiment of a filtration device 200 is shown in FIGS. 4-6. The alternate embodiment of the filtration device 200 is similar to the above-described filtration device 100 and comprising of essentially the same features configured and integrated in a similar way. The filtration device 200 comprises of a reservoir 202, a cover 204, an inlet 206, an outlet 208, an internal pipe portion 208a, a vent 210, and a float switch 212. The reservoir 202 may have a top end 202a and a bottom end 202b wherein the top end 202a connects to a bottom end 204b of the cover 204 and a magnetic element 220 is disposed at the bottom end 202b of the reservoir. A top end 204a of the cover 204 is integrated with the vent 210 and the float switch 212. A grip portion 205 is also configured on the top end 202a of the cover 202. The filtration device 200 further comprises of a solenoid valve 214 which is electrically connected to the float switch 212. The solenoid valve 214 is integrated into a pipe 216 that is connected to the outlet 208 and the condensate drain line 506 (See, FIG. 8). The solenoid valve 214 may be a two-way valve having two ports that are normally closed.

In this non-limiting embodiment of the filtration device 200, the float switch 212 is normally open and the solenoid valve 214 is normally closed as mentioned above. When the float switch 212 is open, the condensate flowing through the condensate drip line 506 will flow through the inlet 206 and into the reservoir 202. When there is a clog in the filtration device 200 or somewhere downstream of the filtration device 200, the reservoir 202 will fill up with condensate and when the level of condensate in the reservoir reaches the float switch 212, the solenoid valve 214 will be triggered to open and the condensate will be directed to drip down through pipe 216 rather than enter the reservoir 202 and also prevent the backing up of the condensate in the condensate drip line 506. In this embodiment, the HVAC unit continues to operate and is not shut off while the condensate is diverted to exit from the pipe 216 with the solenoid valve 214 open.

FIGS. 7 and 8 illustrate the filtration device 100, 200 connected to the condensate drain line 506 of a HVAC system 500. Generally, the condensate drain line 506 may be cut through and the filtration device 100, 200 may be placed between the cut portion and connected to the condensate drain line 506 via the inlet 106 and outlet 108 on the cover 104. As the HVAC system's air handling unit 502 has a liquid running through an evaporator coil 504, condensate 508 may form, and this condensate 508 may collect and be drained out of the system via the condensate drain line 506. As the condensate 508 flows, it may contain magnetic particles and other debris which will flow through the condensate drain line 506 and into the filtration device 100, 200 via the inlet 106, 206 on the cover 104, 204. The magnetic particles are attracted to the magnetic element 120, 220 at the bottom end 102b, 202b of the reservoir 102, 202. Additionally, debris beside magnetic particles also settle to the bottom end 102b, 202b of the reservoir 102, 202. Thus, metal particles and debris that can clog the condensate drain line 506 may be conveniently removed. The metal particles and debris are collected in the filtration device 100, 200 which can be drained and easily cleaned by removing the magnetic element 120, 220 or unscrewing the reservoir 102, 202 from the cover portion 104, 204, or doing both. When unscrewing and removing the reservoir 102, 202, the cover 104, 204 conveniently remains connected to the drain line 506.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A filtration device for connecting to a drainage pipe of a heating, cooling, and/or ventilation system, the filtration device comprising:
a reservoir, having a hollow body with an interior volume, wherein the reservoir has a top end and a bottom end, wherein the bottom end is closed and the top end is open;
a cover having a top end and a bottom end, wherein the top end is closed and the bottom end is open, wherein the cover is configured to sealingly connect to the reservoir;
an inlet and an outlet configured on the cover;
a vent configured at the top end of the cover; and
a float switch integrated into the cover, wherein the float switch is electrically connected to shut off the heating, cooling, and/or ventilating system unit, wherein the float switch is actuated when a condensate level within the reservoir reaches and contacts the float switch.

2. The filtration device of claim 1, wherein the reservoir is manufactured as a one-piece reservoir instead of separately connectable to the cover, and wherein the inlet and the outlet are configured on the reservoir.

3. The filtration device if claim 1, wherein the top end of the reservoir and the bottom end of the cover matingly engage with each other to form an enclosed structure.

4. The filtration device of claim 1, wherein the reservoir is fashioned from a transparent or a clear material.

5. The filtration device of claim 1, wherein a grip is configured on an outside surface of the top end of the reservoir.

6. The filtration device of claim 1, wherein a magnetic element is disposed at the bottom end of the reservoir.

7. The filtration device of claim 6, wherein the magnetic element is formed as a plug that matingly engages with an opening in the bottom end of the reservoir, wherein the magnetic element can be removably secured to the opening in the bottom end of the reservoir.

8. The filtration device of claim 1, wherein the inlet and the outlet are connected to a condensate drain line of a heating, cooling, and/or ventilating system.

9. The filtration device of claim 1, wherein the float switch is integrated into the top end of the cover and extends into the cover.

10. The filtration device of claim 9, wherein the float switch is positioned above the outlet

11. A filtration device for connecting to a drainage pipe of a heating, cooling, and/or ventilating system, the filtration device comprising:
a reservoir, having a hollow body with an interior volume, wherein the reservoir has a top end and a bottom end, wherein the bottom end is closed, and the top end is open;
a cover having a top end and a bottom end, wherein the top end is closed, and the bottom end is open, wherein the cover is configured to sealingly connect to the reservoir;
an inlet and an outlet configured on the cover, wherein the inlet and the outlet configured on the cover for condensate flow into and out of the reservoir, respectively;
a vent configured at the top end of the reservoir; and
a float switch integrated into the cover; and
a solenoid valve integrated to a pipe, wherein the pipe is connected to the inlet, and wherein the float switch is electrically connected to the solenoid valve such that the float switch triggers the solenoid valve to open when a condensate level within the reservoir reaches and contacts the float switch.

12. The filtration device of claim 11, wherein the reservoir is manufactured as a one-piece reservoir instead of separately connectable to the cover, and wherein the inlet and the outlet are configured on the reservoir.

13. The filtration device if claim 11, wherein the top end of the reservoir and the bottom end of the cover matingly engage with each other to form an enclosed structure.

14. The filtration device of claim 11, wherein the reservoir is fashioned from a transparent or a clear material.

15. The filtration device of claim 11, wherein a grip is configured on an outside surface of the top end of the reservoir.

16. The filtration device of claim 11, wherein a magnetic element is disposed at the bottom end of the reservoir.

17. The filtration device of claim 16, wherein the magnetic element is formed as a plug that matingly engages with an opening in the bottom end of the reservoir, wherein the magnetic element can be removably secured to the opening in the bottom end of the reservoir.

18. The filtration device of claim 11, wherein the inlet and the outlet are connected to a condensate drain line of a heating, cooling, and/or ventilating system.

19. The filtration device of claim 11, wherein the float switch is integrated into the top end of the cover and extends into the cover.

20. The filtration device if claim 19, wherein the float switch is positioned above the outlet.

21. The filtration device of claim 11, wherein when the solenoid valve is open, the condensate flows into the pipe the solenoid valve is integrated into to drain to an outside.
